(19) United States
(12) Patent Application Publication
(10) Pub. No.: US 2022/0274697 A1
(43) Pub. Date: Sep. 1, 2022

(54) AERODYNAMIC TECHNIQUES AND METHODS FOR QUIETER SUPERSONIC FLIGHT

(71) Applicant: chuanrui zhang, Tianjin (CN)

(72) Inventor: chuanrui zhang, Tianjin (CN)

(21) Appl. No.: 17/614,364

(22) PCT Filed: Jul. 1, 2019
(86) PCT No.: PCT/IB2019/055577

§ 371 Date: Feb. 11, 2022

(51) Int. Cl. B64C 30/00; B64C 23/04; B64C 1/00

(52) U.S. Cl. CPC B64C 30/00; B64C 23/04; B64C 1/0009; B64D 2033/026

(57) ABSTRACT

This invention is focus on how to make a quieter supersonic flight. Several techniques and methods have been crafted to solve the noise problem of the sonic boom. Sonic boom is propagated from aircraft to the ground, so add interference media between them to block the noise wave could reduce the sonic boom level. Using special designed wings could also reduce noise wave. Part of the special wings design is inspired from the bird flock's flight. Using active shock wave to blow away the air at the windward front of the aircraft or using holes at the fuselage bottom to flow away the air underneath the fuselage could reduce the noise wave propagated to travel to the ground.

### BACKGROUND

The advent of Concorde and Tu-144 started a new era for commercial airlines, they were thought to be a milestone of pursuing higher speed aircrafts in the commercial aviation history. Although they created world records for commercial airplanes, their tremendous noise during the flight remains as a major problem. Therefore the FAA (federal aviation administration) made a regulation prohibiting supersonic flight over land, which restrict its usage in domestic aviation for most continental countries. Since then many efforts have been made to solve the noise problem, but it still remains as a challenge for aircraft design.

### SUMMARY

This invention is focus on how to make a quieter supersonic flight. Several techniques and methods have been crafted to solve the noise problem of the sonic boom. Although each of these methods could mitigate the sonic boom, combination of these methods could also be used to archive maximum performance. Part of this invention is based on a little different mechanical explanation of sonic boom in contrast to the classic and gained some inspiration from the aerodynamic advantage of the bird flock's flight. Sonic boom is propagated from aircraft to the ground, so add interference media between them to block the noise wave could reduce the sonic boom level. Using special designed wings could also reduce noise wave. Part of the special wings design is inspired from the bird flock's flight. Using active shock wave to blow away the air at the windward front of the aircraft or using holes at the fuselage bottom to flow away the air underneath the fuselage could reduce the noise wave propagated to travel to the ground.

When an aircraft configured with flat bottom of the fuselage and fly at almost zero angle of attack, it should produce less sonic boom noise, meanwhile it need special designed wings. Although most aircrafts have lift generated from thrust to balance gravity during flight, there still be bumps on the air underneath the fuselage and wings, this might be another source of noise wave. So add holes at the bottom of the fuselage of the traditional aircraft to guide the underneath air to flow away should further reduce such “bumps” could mitigate the sonic boom signature.

According to one embodiment disclosed herein, a method for interfering with an aircraft component expansion wave is provided. The method includes spreading air flow from a nozzle which connected to the fuselage to interfere with the aircraft expansion wave.

According to another embodiment disclosed herein, an apparatus to mitigate the sonic boom is provided. The apparatus includes an air flow source, a pipe, and a nozzle at the end of the pipe to spread the air flow to interfere with expansion wave.

According to another embodiment disclosed herein, an aircraft with quieter supersonic flight is provided. The aircraft includes a fuselage and a pipe installed on the fuselage, an air flow source, and a nozzle connected by the pipe to spread the air flow.

According to another embodiment disclosed herein, a method for interfering with an aircraft component expansion wave is provided. The method includes an interference media where air flow spread from a nozzle connected the aircraft and the aircraft component expansion wave met, the interference media is used for preventing the expansion wave from propagating to the ground.

According to another embodiment disclosed herein, an apparatus to mitigate the sonic boom is provided. The apparatus include an air flow source, a pipe, and a nozzle to spread the air flow and a interference media where the air flow and expansion wave met for interfering.

According to another embodiment disclosed herein, an aircraft with quieter supersonic flight is provided. The aircraft includes a fuselage, a pipe, an air flow source, and a nozzle connected by the pipe to spread air flow, and an interference media where the air flow and the expansion wave met.

According to another embodiment disclosed herein, an aircraft with special designed wings is provided. The aircraft includes a fuselage and multiple rotatable wings installed at the top and/or sides of the fuselage.

According to another embodiment disclosed herein, an aircraft with quieter supersonic flight is provided. The aircraft includes a fuselage with flat bottom, and multiple rotatable wings installed on the top and/or sides of the fuselage.

According to another embodiment disclosed herein, an apparatus to mitigate sonic boom is provided. The apparatus includes a shock wave generator, and a nozzle to spread shock wave in the front of the windward of the aircraft.

According to another embodiment disclosed herein, an aircraft with quieter supersonic flight is provided. The aircraft includes a fuselage, a shock wave generator, and a nozzle to spread shock wave in the front of the windward of the aircraft.

According to another embodiment disclosed herein, an apparatus to mitigate sonic boom is provided. The apparatus includes a fuselage, concave holes at the bottom of the fuselage.

According to another embodiment disclosed herein, an aircraft with quieter supersonic flight is provided. The aircraft includes a fuselage, concave holes at the bottom of the fuselage to to flow away the air underneath during flight.

According to another embodiment disclosed herein, an aircraft with maximum performance of silence for supersonic flight is provided. The aircraft uses a combination of the methods disclosed from this invention.

### BRIEF DESCRIPTION OF THE DRAWINGS

FIG. 1 is side-up view of an aircraft configured with a nozzle connected to the fuselage to spread the air flow in accordance with an embodiment of the present technology.

FIG. 2 is side-up view of an aircraft configured with a nozzle connected to the fuselage to spread the air flow, and an interference media for interfering in accordance with an embodiment of the present technology.

FIG. 3 Three different materials for interference media in according with an embodiment of the present technology.

FIG. 4 illustrated the position of the interference media in calculation in according with an embodiment of the present technology.

FIG. 5 is a side view of an aircraft configured with special designed wings which show an discrete distribution pattern in according with an embodiment of the present technology.

FIG. 6 is a close view of an aircraft configured with different wing types in according with an embodiment of the present technology.

FIG. 7 is a side view of an aircraft configured with special designed wings and fuselage with flat bottom in according with an embodiment of the present technology.

FIG. 8 is side view of an aircraft configured with a shock wave generator, special designed wings, and a nozzle to spread shock wave in according with an embodiment of the present technology.

FIG. 9 is a bottom view of a aircraft configured with holes at the bottom of the fuselage in according with an embodiment of the present technology.

FIG. 10 shows detail view of the structure of the concave holes at the bottom of the fuselage in according with an embodiment of the present technology.

FIG. 11 is a side-up view an aircraft configured with special designed wings, fuselage with holes at bottom, and shock wave generator, and nozzle to spread shock wave at the windward of the aircraft to archive maximum performance of silence in according with an embodiment of the present technology.

FIG. 12 close view of the top wings of the aircraft which show a similar distribution pattern to the bird flock in according with an embodiment of the present technology.

FIG. 13 is a close view of an aircraft with special designed wings at the front part of the fuselage in according with an embodiment of the present technology.

### DETAILED DESCRIPTION

When an aircraft flying at supersonic or hypersonic speed, there will be a sonic boom generated underneath the flying path. The following detailed description is directed to techniques and methods to mitigate the sonic boom noise.

### Technique 1:

The sonic boom wave is generated from the aircraft to the ground. So the technique 1 is blocking the wave in middle of it to prevent the noise wave from traveling to the ground. The technique 1 have an active air flow source which could generated from an air flow generator or from the intake of the aircraft, the air flow spread from the nozzle to interfere the aircraft expansion wave to mitigate the sound wave. And it could be extended even further, an interference media is set between the expansion wave the the air flow which could block the sound wave.

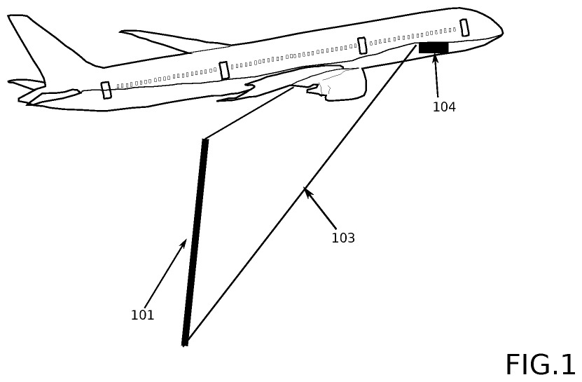

FIG. 1 is a side-up view of an aircraft configured to have an air flow source 104, a spread nozzle 101, and pipes 103 transmit the air flow. The nozzle is located underneath the aircraft to spread air flow in the up-back direction. The air flow spread from the nozzle will mitigate the aircraft component expansion wave.

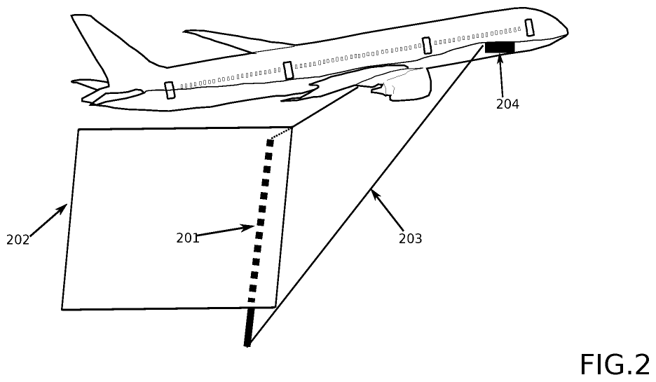

FIG. 2 use similar technique to FIG. 1 with additional interference media to block the expansion wave generated from the aircraft directly. FIG. 2 also have an air flow source 204, pipe 203 to transmit air flow to the underneath nozzle 201, and interference media 202 where the air flow and expansion wave will met which will block the expansion wave from propagating to the ground.

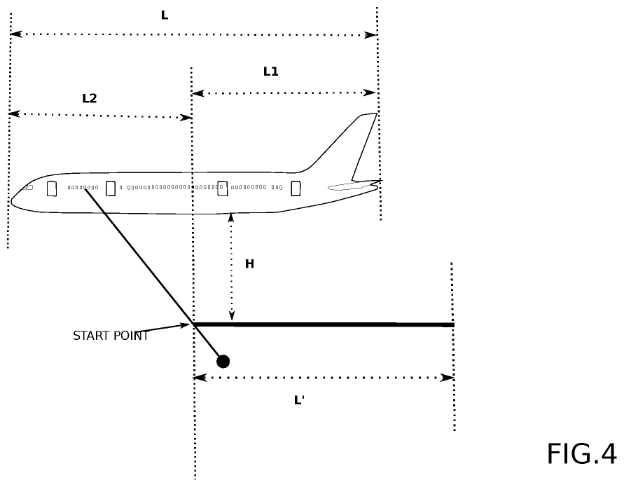

The position and length of the interference media must satisfied the following condition in FIG. 4:

H>=L2;

L′>=L1+M*H;

where H is the length from the start point of the interference media to the bottom of the aircraft.
L2 is the horizontal distance from start point of the interference media to the front of the aircraft.
L1 is the horizontal distance from start point of the interference media to the rear of the aircraft.
L=L1+L2 equals the length of the aircraft.
M is the mach number of the max aircraft speed.
L′ is the length of the interference media.
The optimal H is H=L2, since it must guarantee the expansion wave generated from the front must be blocked by the interference media. The second equation is guarantee the expansion wave from the rear part of the aircraft also need to be blocked by the interference media.

For example, if M=3.0, L2=0.5*L,

L′>=L1+M*L2=L2+L1+(M−1)*L2

L′>=2*L;

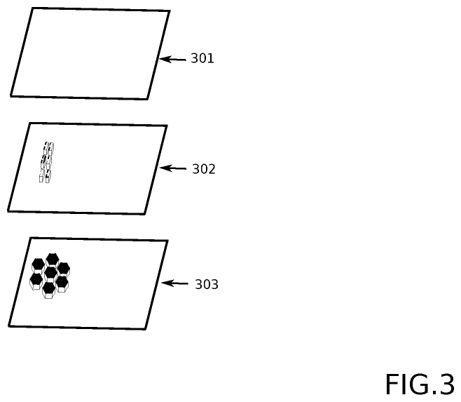

which means, if the aircraft flying at 3 Mach speed, the length of the interference media is at least twice of the length of the aircraft.
FIG. 3 show three different materials which could be used for the interference media.
Interference media 301 is made of material similar to parachute (such as nylon, dacron, kevlar, silk etc.). The expansion wave and the air flow will met at the interference media which could cancel out the sound wave.
Interference media 302 is made of acoustic metamaterial on the upper side to control the transmission and reflection of the sound wave. The reference provided detailed description of the theory behind it[1].
Interference media 303 is also made of acoustic metamaterial, but configured with an open structure, which will reflect the the sound wave but let the air flow through. Detailed information could be found[2].
   To additionally reduce the noise level of the pipes 103 in FIG. 1 and pipes 203 in FIG. 2 during flight, an plasma actuator could also be used[3].

Special Designed Wings:

Since the advent of airplane, most aircrafts have wings. But the shape and the structure of the wings haven't changed drastically from the beginning. Although this invention introduced a special designed wings which combined with other technique to mitigate sonic boom noise, it could also be used for other types of aircraft.

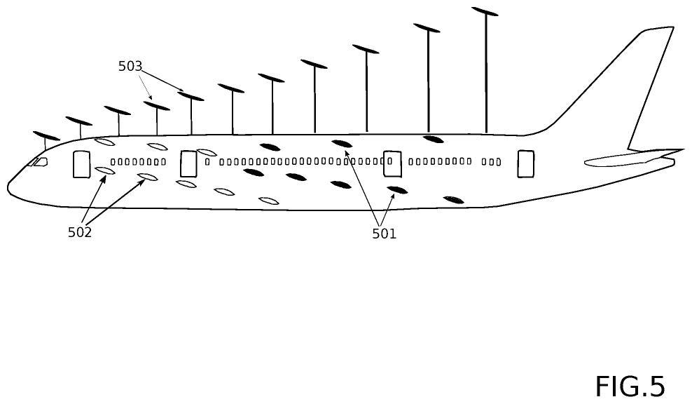

FIG. 5 is a side view of an aircraft configured with special designed wings which show a discrete distribution pattern. The wings design is inspired from the aerodynamic advantage of bird flock's flight. Wings 503 are multiple rotatable smaller wings installed at the top of the aircraft, the height of the wings will be increased progressively. Wings 501 and Wings 502 are multiple rotatable smaller wings installed at the both sides of the aircraft.

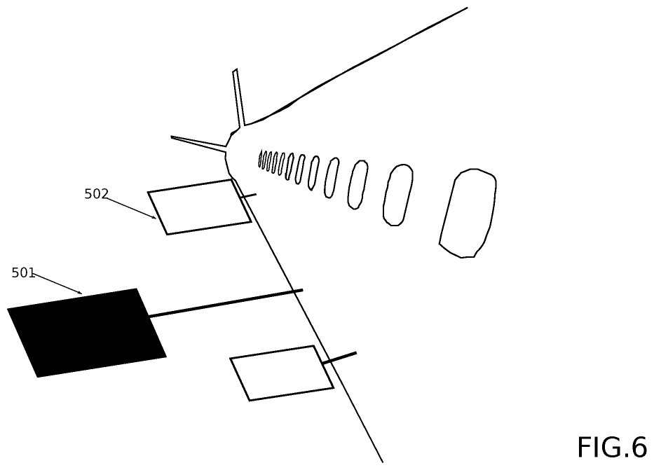

FIG. 6 show a close view of the installed wings of the aircraft. Wings 502 are distributed similar to Wings 501. Both are inspired from the bird flock. As clearly showed in FIG. 6, the wings 501 have far distance to the fuselage as to wings 502.

The special designed wings also have another advantage. For most traditional commercial aircrafts, when takeoff and landing, the fuselage must head up or down accordingly. While the aircraft with special designed wings could hold the fuselage horizontally during take off and landing, which make the passengers more comfortable. Since using special designed wings, things like stalling will almost never happen at least in theory.

### Technique 2:

Aircraft configured with the special designed wings could reduce the expansion wave which propagated to the ground, since it comprise special designed wings installed at the top of the fuselage. If the aircraft configured with a fuselage with flat bottom and flying at almost zero angle of attack which could guaranteed by precisely control the angle of each individual smaller wings dynamically during the flight, it should produce less sonic boom noise to the ground.

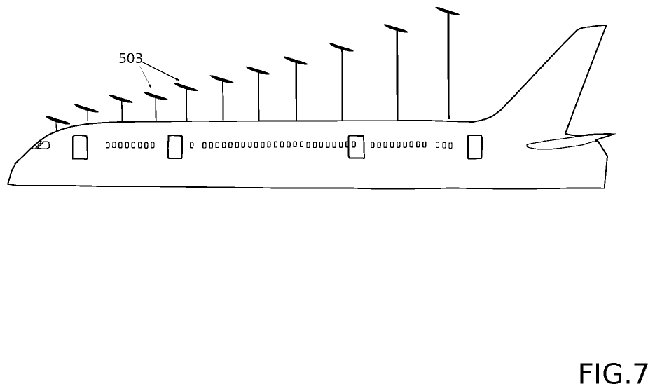

FIG. 7 is a side view of an aircraft configured with a flat bottom, and special designed wings. Wings 503 could be operated dynamically during flight. There is a computer system to precisely control individual angle of the wings which will make sure the aircraft keep almost zero angle of attack during the flight.

### Technique 3:

To solve the sonic boom noise problem, actually it only need reduce the noise level propagated to the ground even it increase noise level propagated to up. So the technique 3 is try to move the noise to go up instead of underneath. By using an high powered shock wave generator, which spread from nozzles to below away the air in front of the aircraft to reduce expansion wave propagated in front and underneath of the aircraft.

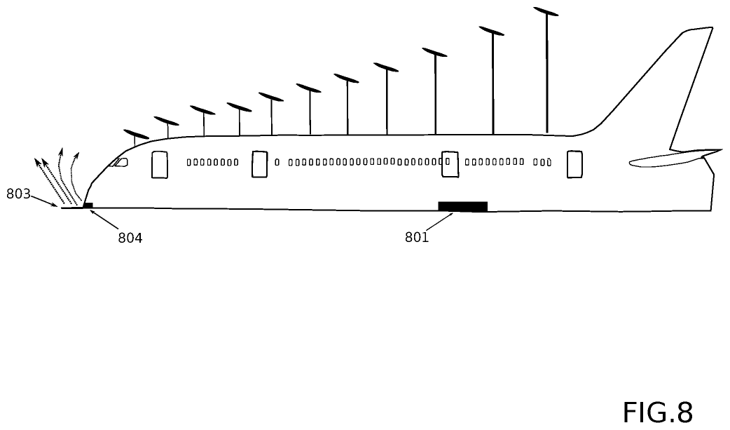

FIG. 8 is a side view of an aircraft configured with a shock wave generator 801, nozzle 804 to spread shock wave to front of the aircraft, nozzle 803 to spread shock wave to go up, these nozzles will keep the air in front of the aircraft to go up instead of accumulation.

### Technique 4:

Although most aircraft have lift generated from thrust to balance gravity during flight, there still be bumps on the air underneath the fuselage and wings, this might be another source of noise wave. So add holes in the bottom of the fuselage of the traditional aircraft to guide the underneath air to flow away should reduce such “bumps” which could mitigate the sonic boom signature.

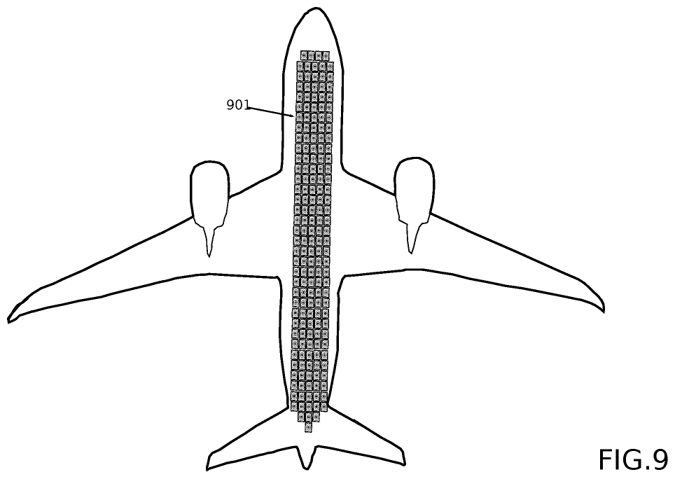

FIG. 9 is a bottom view of an aircraft with holes 901 at the bottom of the fuselage. There are also pipes to guide air underneath the fuselage to flow out the aircraft. The size and distribution of the holes could be determined by experiment to get best efficiency. There is also could have a mechanism to actively pump out the air in the holes and pipes. The less air gathered underneath the fuselage, the less possibility there will generate noise sound wave.

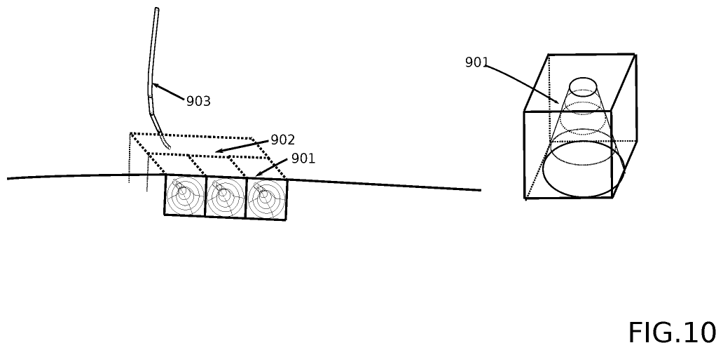

FIG. 10 show a profile diagram of the holes 901, there could be a cavity 902, and pipes 903 to guide the air to flow out the aircraft. The air could also be pumped out actively.

### An Optimal Aircraft for Quieter Supersonic Flight

As an embodiment disclosed herein, an optimal aircraft by using techniques introduced by this invention for quieter flight is provided.

The optimal aircraft for quieter supersonic flight looks quiet different from traditional aircraft because it put high priority for silence design.

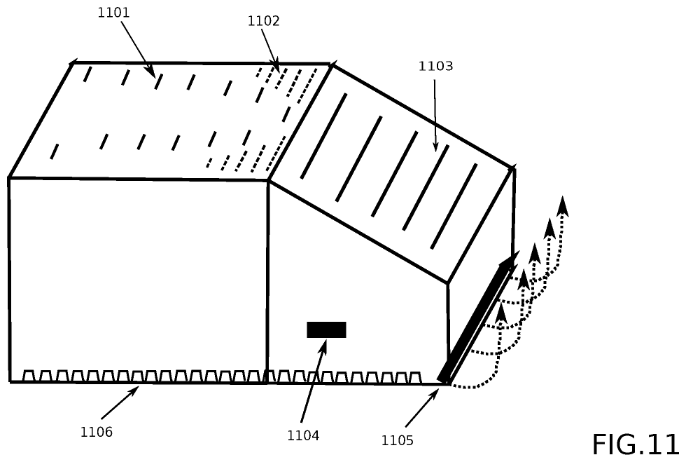

FIG. 11 is an overview of the quieter aircraft. As it depicted the shape of the aircraft looks like a box and a quadrangular prism with one oblique surface united together. There are holes 1106 at the bottom of the fuselage as described in Technique 4. Although using Technique 4, the fuselage also make its bottom as “flat” as possible as described in Technique 2. A shock wave generator 1104, a nozzle 1105 to spread shock wave depicted in the FIG. 11 as described in Technique 3. To maximum performance for silence the wings are installed at the top of the fuselage.

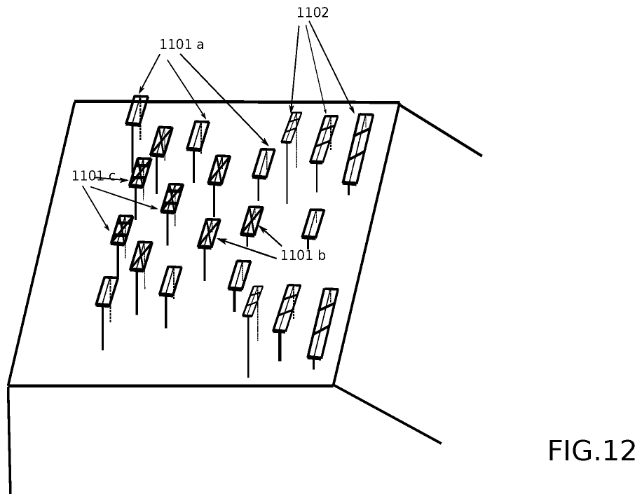

FIG. 12 is a close view of the wings installed at the top of fuselage. The distribution of the wings 1101 are inspired from the bird flock, the height of the wings 1101 is increased progressively. Wings 1102 are parallel smaller wings, their height are also increased progressively to get more windward area. As depicted in FIG. 11, there are many duplicate wings similar to Wings 1101 and Wings 1102 to fill the top of the aircraft (Wings 1101a, Wings 1101b, Wings 1101c and etc.).

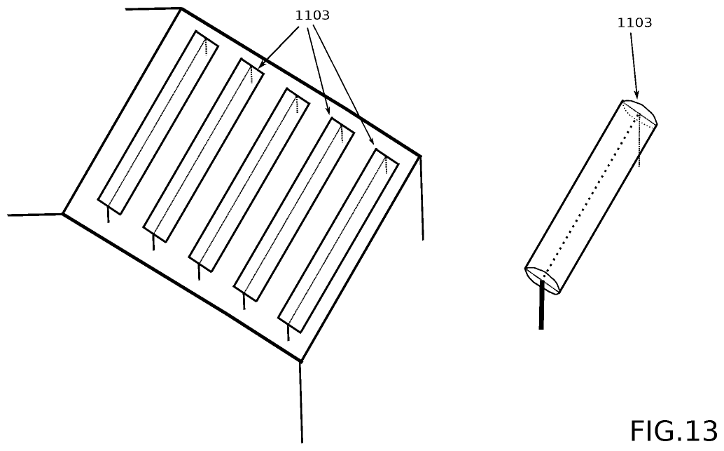

FIG. 13 is a close view of the Wings 1103 installed at the top front of the fuselage. Wing 1103 is an individual rotatable smaller wing.

All the smaller wings (Wings 1101, Wings 1102, Wings 1103) are rotatable during flight. There is also a computer system to precisely control the angle of the individual smaller wings to get exactly lift to balance the gravity and keep almost zero angle of attack during flight. Which also make the passengers more comfortable during takeoff and landing.

This conceptional design provide one embodiment, it is obvious easy to get other designs by using combination of the technique described above. All these design should also be considered as portions of this invention.

And all the techniques and methods disclosed herein could also be applied for hypersonic flight or even higher speed flight. All the application to these field by using the techniques and methods described above should also covered by this invention.

The embodiment disclosed herein as described above should not be limited from the true spirit of the principle to solve the noise problem. Since it is obvious easy to use a combination of techniques and methods described above, these should also be covered by this invention.

### REFERENCE

[1]. Junfei Li, Chen Shen, Ana Diaz-Rubio, SeiA. Tretyakov, Steven A. Cummer. Nature Communication, 2018; Systematic design and experimental demonstration of bianisotropic metasurface for scattering-free manipulation of acoustic wavefront.
[2]. Reza Ghaffarivardavagh, Jacob Nikolajczyk, Stephan Anderson, Xin zhang. Physical Review B, 2019; Ultra-open acoustic metamaterial silencer based on Fano-like interference.
[3]. Flint O. Thomas, Alexey kozlov amd Thomas C. Corke. AIAA Journal Vol 46, No. 8, August 2008. Plasma Actuators for Cylinder Flow Control and Noise Reduction.

1. An apparatus for mitigating sonic boom during supersonic flight, which comprising of:
an air flow source;
a device let the air flow transmit through; and
a nozzle to spread the air flow.

2. An aircraft configured to reduce sonic boom, which comprising of:
fuselage;
an air flow source;
a device let the air flow transmit through;
a nozzle connected to the device to spread the air flow.

3. An apparatus for mitigating sonic boom during supersonic flight, which comprising of:
an air flow source;
a device let the air flow transmit through;
a nozzle to spread the air flow; and
an interference media for interfering.

4. An aircraft configured to reduce sonic boom, which comprising of:
fuselage;
an air flow source;
a device let the air flow transmit through;
a nozzle connected to the device to spread air flow; and
an interference media to block the expansion wave from the aircraft component by interfering with the air flow.

5. An aircraft comprising of:
fuselage;
multiple rotatable wings installed on top and/or sides of the fuselage.

6. An aircraft configured to reduce sonic boom, which comprising of:
fuselage with flat bottom;
multiple rotatable wings installed on top and/or sides of the fuselage.

7. An apparatus for mitigating sonic boom during supersonic flight, which comprising of:
a shock wave generator;
nozzles to spread the shock wave at the windward front of the aircraft.

8. An aircraft configured to reduce sonic boom, which comprising of:
fuselage;
a shock wave generator;
nozzle to spread the shock wave at the windward front of the aircraft.

9. An apparatus to mitigating sonic boom during supersonic flight, which comprising of:
fuselage with holes at the bottom;
pipes to guide the air underneath the fuselage to flow out the aircraft.

10. An aircraft configured to reduce sonic boom, which comprising of:
fuselage with holes at the bottom;
pipes to guide the air underneath the fuselage to flow out the aircraft;

11. An aircraft configured to archive optimal performance of silence in supersonic flight, which comprising of:
fuselage with flat bottom and holes at the bottom;
multiple rotatable wings installed at the top of the fuselage;
a shock wave generator; and
nozzles to spread shock wave at the windward front of the aircraft.
